(19) United States
(12) Patent Application Publication
(10) Pub. No.: US 2014/0043160 A1
(43) Pub. Date: Feb. 13, 2014

(54) FAIL-SAFE ALARM ACTIVATION SYSTEM

(71) Applicants: Erwin Holowick, Oakbank (CA); R. Kemp Massengill, Leucadia, CA (US)

(72) Inventors: Erwin Holowick, Oakbank (CA); R. Kemp Massengill, Leucadia, CA (US)

(73) Assignee: Mednovus, Inc., Leucadia, CA (US)

(21) Appl. No.: 13/572,151

(22) Filed: Aug. 10, 2012

(51) Int. Cl. G01N 21/84; G08B 13/02; G01J 5/00

(52) U.S. Cl. 340/568.1; 250/221; 250/338.1

(57) ABSTRACT

The present invention provides an apparatus and method for ensuring that a pass-by detector system is placed in “ready-to-alarm” mode when a subject carries a ferromagnetic threat, or an inanimate ferromagnetic object independent of a human subject passes within the physical zone designated for alarming to such a threat. A fail-safe alarm system consisting of dual detection systems solves the failure of motion-detection systems when confronted with non-heat producing ferromagnetic threat objects; and the failure of photo-beam detection systems when confronted with black, non-reflective clothing. Applications for the present invention include pre-MRI safety screening, as well as certain security protocols, such as banks, schools, prisons, and courthouses.

### BACKGROUND OF THE INVENTION

1. Field of the Invention

This invention is in the field of magnetic resonance safety screening for dangerous ferromagnetic threat objects, with applications for security screening, such as banks, schools, and courthouses.

2. Background Art

Magnetic Resonance Imaging (MRI) has been called “the most important development in medical diagnosis since the discovery of the x-ray” over 100 years ago, with an estimated 8,200 MRI facilities in the U.S. and an additional 15,000 overseas. Companies selling MRI systems include GE Healthcare, Siemens, Philips, Toshiba, Fonar, and Hitachi. It is estimated that 28 million MRIs are performed per year in the United States.

MRI is a less invasive diagnostic modality than x-ray imaging, since it involves no ionizing radiation. It is safer than positron emission tomography (PET), involving no ingestion of radioactive isotopes. Although touted as an inherently safe diagnostic procedure, MRI does carry attendant risks, which are becoming more apparent as both the number of MRI procedures performed increases, and newer MRI systems operating at ever-higher magnetic fields replace weaker systems.

The strong magnetic field of the MRI magnet—and, in particular, the strong field gradients the magnet produces—causes ferromagnetic objects to be suddenly propelled toward the magnet, sometimes with catastrophic results. Called the “projectile missile threat,” numerous injuries to patients have occurred, including at least two tragic deaths. Damage to the magnet itself, caused by the impact of the attracted objects, is also a significant, and costly, problem.

Until the recent advent of ferromagnetic detection systems, MRI facilities have relied on staff training and signage to exclude hazardous items from the magnet room. Despite training, signage, patient interviews, and medical record review, hazardous items still enter the magnet room, and the number of reported accidents has been increasing over time.

Dr. Emanuel Kanal, Professor of Radiology and Neuroradiology at the University of Pittsburgh Medical Center (UPMC), is a world-renowned expert in magnetic resonance safety and the lead author of the MRI Safety White Papers, first published in the American Journal of Radiology in 2002, and updated in 2004 and 2007.

In conjunction with GE Healthcare, Dr. Kanal's video, “Safety in the MRI Suite: What You Need to Know,” vividly demonstrates the disastrous threat potential of a ferromagnetic object in a high-field, high-gradient region of an MRI magnet. The video shows a pipe wrench instantaneously taking flight and hurtling toward the MRI magnet. The force of attraction causes the wrench to accelerate and strike a protective brick barrier in front of the MRI magnet with such force that it pulverizes several of the bricks.

This potential was tragically illustrated in 2001 when a cylinder of compressed oxygen—a ferromagnetic cylinder—was mistakenly brought into an MRI room. Wrenched from the operator's control, it crushed the skull of a young patient as it sped into the magnet. The Kanal/GE video and other references document numerous ferromagnetic threat objects that have become attached to MRI magnets, including wheelchairs, gurneys, floor scrubbers, and even file cabinets. Dr. Kanal terms the projectile missile threat “Public Enemy Number One.”

Smaller ferromagnetic objects also present threats, and numerous accidents have occurred. One tragic case was the sudden and catastrophic movement of a ferromagnetic aneurysm clip in the brain of an unfortunate patient, causing her death. The staff apparently had obtained information indicating that the material in this clip could be scanned safely [Klucznik et al., “Placement of a Ferromagnetic Intracerebral Aneurysm Clip in a Magnetic Field with a Fatal Outcome.” Radiology, June 1993, pp. 855-856].

A feature article beginning on the front page of the New York Times related many other accidents caused by the strong magnetic field and gradients of MRI systems [D. G. McNeil, Jr., “M.R.I.'s Strong Magnets Cited in Accidents.” New York Times, Aug. 19, 2005].

In addition to ferromagnetic objects and instruments which are carried into the MRI magnet room, detection is also needed for biostimulation devices, such as defibrillators and pumps, and their power supplies. The U.S. has a population of over 2,900,000 patients with pacemakers alone. Despite diligent efforts to reduce the ferromagnetic content of such implants, most of them still have ferromagnetic components, especially in the batteries, and appear likely to have such for the foreseeable future. The age of the pacemaker population means that a significant number of them may not be reliable informants, due to forgetfulness, confusion, or full-blown dementia; and, in an emergency room situation, they may be unresponsive. Their medical records may also be unavailable.

### BRIEF SUMMARY OF THE INVENTION

It is problematic with metal detector systems, including ferromagnetic detectors used for pre-MRI safety screening, that dangerous threats can be missed because the ferromagnetic pass-through detection system in certain circumstances is not placed into the activated “ready-to-alarm” mode required to alarm on such threats. This result is non-performance of the system and a false negative “miss” which could seriously injure a patient or staff member.

And it is undesirable to leave the detector continuously in the activated “ready to alarm” mode, because unwanted alarms would be occurring constantly—and even when patients, staff, or instrumentation were not traversing the designated alarm pathway of the detector system. This extreme annoyance would cause most facilities to simply turn off the system, thereby losing all benefit of this line of defense against projectile missile threats.

Implementations of the present system and method described herein provide solutions for these major concerns.

The SAFESCAN® STAR™ is a single-pillar system of Mednovus, Inc. (Leucadia, Calif. USA) designed to detect ferromagnetic materials when a subject passes by the pillar within the pillar's specified zone for ferromagnetic detection. If a ferromagnetic threat object is detected by the pillar, an alarm, which may include both audio and visual components, is automatically activated. This alarm indicates that the subject must be stopped before proceeding further, such as entering a restricted area. This is typically the MRI magnet room, as it is within the MRI magnet room where disaster occurs. It is here that a significant ferromagnetic object is turned into a dangerous projectile missile, propelled dangerously toward the bore of the MRI magnet in jet-like fashion.

The ferromagnetic-detection sensor array of the SAFESCAN® STAR™ pillar may be enclosed in a single vertical tube-like aluminum structure. Detection of threats by this single-pillar system may be single sided, and the pillar may be utilized in a walk-by manner, or by a subject twirling within the specified detection zone. When a person or object passes beside the pillar, it senses the presence of ferromagnetic material(s), and then sounds an audio/visual alarm. This alarm warns that a ferromagnetic object has been detected, and that proceeding past the pillar into the restricted area is forbidden.

The SAFESCAN® STAR™ single-pillar system utilizes, firstly, an infrared (IR) diffusion photo beam to activate the pillar's sensing and alarm functions. The diffusion photo beam triggering the pillar's alarm system must sense the passing of a ferromagnetic object, such as a cart, or a person carrying a ferromagnetic object, within and through a defined area relative to the pillar's operational side; i.e., facing the zone of detection.

Two troublesome and potentially dangerous problems can occur, however, related to the requirement of an IR diffusion photo beam to use a reflective surface to accomplish the designated mission. First, single-sided photo beams, such as diffusion beam systems, operate by transmitting outwardly an infrared beam, and then sensing the return scatter of that beam. The amount of scatter from a diffusion beam is dependent upon the infrared reflective and absorptive characteristics of the object being sensed. Some objects, unfortunately, like black-denim jeans, absorb the beam and are therefore “missed” by the beam. The result is that the pillar is not placed in “ready-to-alarm” mode. A significant ferromagnetic threat can thereby be non-detected, only to enter the MRI magnet room and court catastrophe. Second, other objects, such as chrome wheel chairs, scatter and reflect infrared very well; in fact, sometimes too well. The photo beam subsequently senses these objects from distances beyond the desired range, thereby giving false triggers.

Infrared (IR) motion detectors operate by sensing the movement of an infrared (heat) source. The infrared source, such as the human body, is warmer than the ambient temperature, and is readily sensed when moving. Two problems with motion detectors are as follows. First, the range of sensing a human body is well beyond the desired operating range. Therefore, people on the other side of the room may provoke false triggers. Second, objects like wheel chairs are at ambient temperature and produce no heat. These can pass by a motion detector without providing a trigger.

One can readily perceive that a detection system using only a photo beam, or one using only a motion detector, can be problematic and court danger. In the medical world, false negatives (“misses”) can result in tragedy. The present invention circumvents this potential tragedy with a solution of utilizing both a photo-beam detector and a motion detector. This meets the needs of operating within and through a defined—and limited—area, while alarming both on ferromagnetic threat objects carried by heat-producing humans; and non-heat producing inanimate ferromagnetic objects, such as carts and IV poles.

An implementation of the present system and method would be able to successfully avoid the following bleak scenario: A cart with dangerous ferromagnetic material is pushed through the pillar's alarm zone in front of a technologist. The technologist is carrying no ferromagnetic material. Using only a motion detector, the cart with ferromagnetic material is undetected, because no heat is produced. And by the time that the technologist passes through the alarm zone, no alarm occurs, because the technologist is “ferromagnetically clean.” Unfortunately, the non-heat producing ferromagnetic cart is out of range for the pillar to alarm, and an accident occurs.

An implementation of the present system and method would also be able to successfully avoid the following situation: Using only a photo beam, a patient is screened prior to MRI for dangerous ferromagnetic material. The patient is wearing black clothing, such as a black shirt and black Levi jeans. The photo-beam detector cannot sense the black clothing, because of the insufficient reflective characteristics of the black clothing. The pillar is not placed into “ready-to-alarm” mode. A false negative “miss” now occurs. The patient enters the magnet room and is injured.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a schematic representation of the apparatus of an implementation of the present invention; and

FIG. 2 is a schematic logic diagram according to an implementation of the present invention.

### DETAILED DESCRIPTION OF THE INVENTION

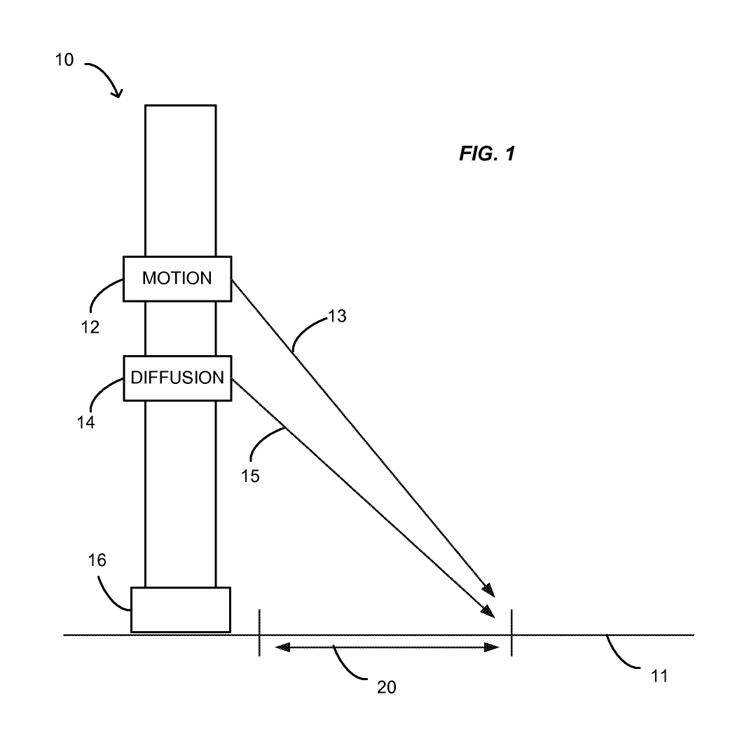

As shown in FIG. 1, the present invention may be embodied in a pillar 10 resting on a floor 11. It will be understood that the pillar 10 may be embodied in a number of ways, with the only requirement being that the same, or a combination of the same, hold two detectors of different types, e.g., a motion detector 12 and a diffusion-type photo-beam detector 14, such that the same have respective lines of sight 13 and 15 gazing at a sensing aperture 20. In more detail, lines 13 and 15 represent centerlines of the fields of view of the different respective sensor-based detectors. The pillar 10 may rest on a base 16, or alternatively, may be mounted on the wall.

The diffusion photo-beam detector 14 may detect infrared (IR) and is sensitive to reflections emanating from objects, those both moving and stationary. Objects such as chairs and light-colored clothing which reflect have a better chance of being sensed. Dark objects, however, such as black carts, or subjects wearing black clothing, are poorly sensed, if at all. To eliminate sensing objects outside the pillar's desired sensing aperture 20, the diffusion photo beam 15 of the SAFESCAN® STAR™ pillar may be appropriately angled down toward the floor.

The motion-detector 12 sensor may also employ IR and is sensitive to moving objects which generate heat, such as human subjects (patients, staff, etc.). The motion-detector sensor's sensitivity and field of view may be accordingly reduced to eliminate sensing objects outside of the desired sensing aperture.

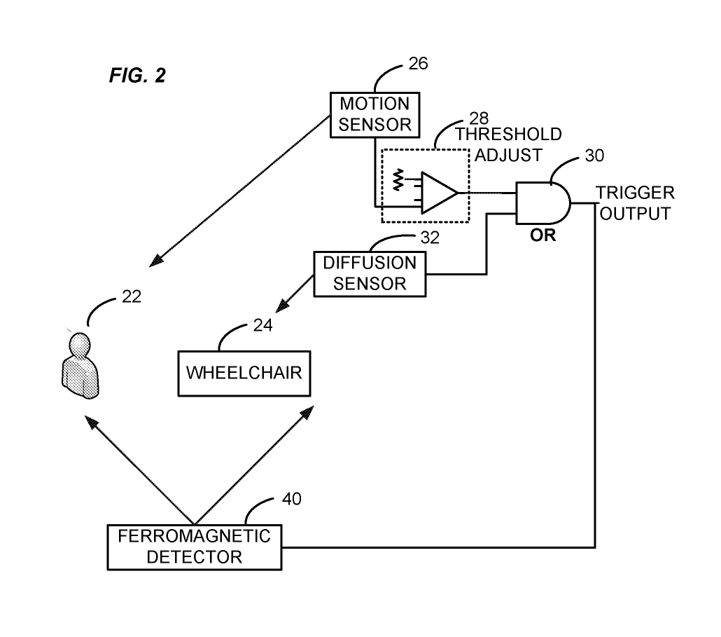

Referring to FIG. 2, a system is illustrated in which at least two sensors are employed to improve the accuracy of a ferromagnetic detector 40 by triggering the same in a reliable way. A motion sensor 26, which is generally part of the motion detector 12, is illustrated coupled to a circuit 28 which allows for adjustment of the motion-detecting threshold. In other words, electronic circuitry may be employed to raise or lower the threshold of the sensor to eliminate false positives or avoid false negatives. The motion sensor 26 measures the presence of moving objects which generate heat, exemplified by a person 22.

A diffusion sensor 32 is also illustrated which, using, e.g., a photo beam, measures movement by measuring a reflected beam, e.g., that caused by a wheelchair 24. The diffusion sensor 32 is generally part of the diffusion detector 14.

A signal from the motion sensor 26, appropriately adjusted in its threshold if necessary, is fed into one input of a logical OR gate or circuit 30. A signal from the diffusion sensor 32 provides another input to the OR gate 30. If either of these signals indicates that an object is present which should be measured for ferromagnetic materials, the trigger output of the OR gate 30 is positive and triggers operation of the ferromagnetic detector 40. This combination reduces the chance of missing objects passing through the sensing aperture. For example, a wheel chair, which is at ambient temperature, may not be detected by the heat-sensing IR motion detector, but is likely to be detected by the object-sensing diffusion photo-beam sensor. Alternately, certain clothing textures may be non-detectable by the diffusion photo-beam sensor, but are likely to be detected by the heat-sensing IR motion detector, because of the heat emanating from the person wearing the clothing.

The motion detector sensor's sensitivity and field of view may be reduced to eliminate sensing objects outside of the desired sensing aperture in three ways: as noted, the threshold may be adjusted e.g., raise, in the electronic circuitry which interfaces to the sensor. The field of view of the sensor may be restricted by covering over areas of the sensors lens with an opaque film. The sensor may be angle downward toward the floor, e.g., the angle of beam 13, to eliminate sensing objects outside the desired sensing aperture 20.

An effective system and method have been presented to trigger activation of a ferromagnetic detector. Both the motion detector and a diffusion detector e.g., photo-beam type detector, are OR'd together to provide the trigger. The diffusion detector reacts to motion as detected by a reflected IR beam. The IR motion detector reacts to heat, such as that generated by a person passing within the range of the motion detector. Such heat is absent, however, if a metal object or instrument, such as an anaesthesia cart or an injector system, is pushed across the beam of the IR motion detector in front of the person pushing the object. No heat is generated by the metal object, as it is at ambient room temperature, and is thus nonrecognizable by the infrared motion detector. And by the time that the pushed object traverses the motion-detector beam, the object threat is out of range of the metal detector system, thus resulting in failure of the detection system. When the system is a ferromagnetic detector designed to alarm on ferromagnetic threats which could cause severe harm, and even death, to a patient undergoing magnetic resonance imaging (MRI), detection failure could easily result in a medical catastrophe.

Systems and methods according to the principles described here require installation with minimum end-user involvement, are self-contained in a one-sided configuration, can be set-up without any separate reflectors or surfaces, and may operate with a range that is coordinated with its ferromagnetic sensitivity.

Variations of the systems and methods will be understood. For example, while a threshold adjustment circuit is disclosed for the motion sensor, it will be understood that some implementations may be provided for the diffusion sensor as well.

While the particular invention as herein shown and disclosed in detail is fully capable of obtaining the objectives and providing the advantages hereinbefore stated, it is to be understood that this disclosure is merely illustrative of the presently preferred embodiments of the invention and that no limitations are intended other than as described in the appended claims.

1. A system for triggering a ferromagnetic detector, comprising:
a. a motion-detector component having a motion-detector output:
b. a photo-beam detector component having a photo-beam detector output; and
c. an OR gate coupled to the outputs of the motion-detector component and the photo-beam detector component; with the output of the OR gate configured to be coupled to a trigger of a ferromagnetic detector, such that upon triggering, the ferromagnetic detector is activated, whereby triggering occurs even if a heat-generating body is covered with light-absorbing material or if a moving body is non-heat generating.

2. The system of claim 1, wherein the motion-detector component or the photo-beam detector component, or both, includes an infrared sensor.

3. The system of claim 1, further comprising a threshold adjustment circuit coupled between the motion-detector component and the OR gate.

4. The system of claim 3, wherein the threshold adjustment circuit and the OR gate are disposed on the same integrated circuit.

5. The system of claim 1, further comprising a threshold adjustment circuit coupled between the photo-beam detector component and the OR gate.

6. The system of claim 1, further comprising the ferromagnetic detector.

7. The system of claim 1, further comprising an alarm for visually or audibly providing a signal when the ferromagnetic detector detects a ferromagnetic object or material.

8. The system of claim 1, wherein both the motion-detector component and photo-beam detector component are angled downward and pointing at a sensing aperture to within plus or minus 25%.

9. The system of claim 1, wherein both the motion-detector component and photo-beam detector component are disposed on a pillar.

10. The system of claim 9, wherein the motion-detector component and photo-beam detector component are configured to detect motion and heat on a single side of the pillar.

11. The system of claim 6, wherein the motion-detector component, photo-beam detector component, and ferromagnetic detector are all disposed on a pillar.

12. A method for triggering a ferromagnetic detector, comprising:
a. providing a motion detector having a motion-detector output;
b. providing a photo-beam detector having a photo beam detector output;
c. placing the output of the motion detector in signal communication with an input of an OR gate;
d. placing the output of the photo-beam detector in signal communication with another input of an OR gate; and
e. using an output of the OR gate to trigger activation of a ferromagnetic detector.

13. The method of claim 12, wherein the providing a motion detector includes providing an infrared motion sensor or wherein the providing a photo-beam detector includes providing an infrared photo-beam sensor.

14. The method of claim 12, further comprising adjusting the threshold of the motion detector or the photo-beam detector.

15. The method of claim 12, further comprising displaying or sounding an alarm when the ferromagnetic detector detects a ferromagnetic object or material.

16. The method of claim 12, further comprising angling the motion detector and photo-beam detector such that both are centered on a sensing aperture to within plus or minus 25%.

17. The method of claim 12, wherein the providing a motion detector and providing a photo-beam detector include providing the motion detector and photo-beam detector on a pillar.

18. The method of claim 17, wherein the motion detector and photo-beam detector detect motion and heat on a single side of the pillar.

19. A non-transitory computer readable medium, comprising instructions for causing a computing environment to perform the method of claim 12.
